(19) United States
(12) Patent Application Publication
(10) Pub. No.: US 2026/0210321 A1
(43) Pub. Date: Jul. 23, 2026

(54) METHOD FOR ARMATURE LIFT FEEDBACK SETTING OF INJECTOR

(71) Applicant: Hyundai Kefico Corporation, Gunpo (KR)

(72) Inventors: Hyun-Jick Lee, Gunpo (KR); Moo-ho Sung, Gunpo (KR); Young-Gyun Jin, Gunpo (KR)

(21) Appl. No.: 19/391,559

(22) Filed: Nov. 17, 2025

(30) Foreign Application Priority Data
Nov. 18, 2024 (KR) 10-2024-0164352

(51) Int. Cl. F02M 61/16; F02M 51/06

(52) U.S. Cl. CPC F02M 61/168; F02M 51/061; F02M 2200/8084

(57) ABSTRACT

A method for controlling an armature lift feedback setting of an injector for a vehicle includes a primary lift that is formed by deforming a positioning ring or a stopper through a primary laser welding in a circumferential direction with a lower end portion of the positioning ring or an upper end portion of the stopper as a first welding portion, and a target lift may be reached through a secondary welding in the circumferential direction performed by a number of weldings set according to a tolerance range of the primary lift with respect to the target lift with a middle portion of the positioning ring or the stopper as a secondary welding portion. The method further includes adjusting the number of weldings according to a variable laser output, thereby precisely obtaining armature lift dispersion with respect to the positioning ring or the stopper.

### CROSS REFERENCE TO RELATED APPLICATION

The present application claims under 35 U.S.C. § 119(a) the benefit of Korean Patent Application No. 10-2024-0164352, filed Nov. 18, 2024, the entire contents of which are incorporated by reference herein.

### BACKGROUND

### (a) Technical Field

The present disclosure relates to vehicle assembly and a method of manufacturing an injector for a vehicle, more particularly, to a method for controlling an armature lift feedback setting of the injector, which may include fixing a stopper or positioning ring by welding and then shrinking an insertion portion.

### (b) Description of the Related Art

Diesel engines may include a common-rail (CR) fuel injection system, in which a valve, armature, and armature pin are critical components of an injector for influencing hydraulic pressure differences in the injector (e.g., diesel injector). Fuel injectors play an important role in impacting energy efficiency and reducing gas and particulate emissions.

Typically, the injector (for example, a gasoline high-pressure injector for an engine of a vehicle) is operated by a solenoid and composed of a magnetic circuit component for generating a magnetic force required for operating the injector, and an injector behavior component, and a needle is lifted by an impact force of the armature, which is generated by the magnetic force of the solenoid.

Accordingly, an armature lift applied to the injector (i.e., a gap from a stopper or positioning ring to the armature) is a key design factor that determines the behavior of the armature at opening and closing timings, and armature lift dispersion affects both behavior and flow rate dispersion.

For example, a larger armature lift increases a damping distance, allowing smoother attenuation of the armature's momentum due to a fluid, but delays the opening timing. Conversely, when the armature lift is small, the damping distance decreases, resulting in poor attenuation of the armature momentum, which can cause bouncing after the positioning ring impact, and when multi-stage injection is applied, an opening behavior of subsequent injection is adversely affected by the occurrence of bouncing.

Accordingly, the armature lift may be set by welding shrinkage caused by relatively high-power laser welding after inserting a stopper component and thus formed as an upper armature lift using a gap (or distance) from the stopper to a top surface of the armature or may be set by welding shrinkage caused by relatively high-power laser welding after inserting a positioning ring component, thereby forming a lower armature lift using a gap (or distance) from the positioning ring to a bottom surface of the armature.

However, laser welding for the armature lift setting considers the fixation of a stopper or positioning ring component with a laser output, and an excessive laser output in this method increases armature lift dispersion, which significantly affects the behavior of a needle/armature and flow rate dispersion.

### SUMMARY

Accordingly, considering the above points, the present disclosure is directed to providing a method for an armature lift feedback setting of an injector for a vehicle, which may reduce dispersion according to armature lift setting by fixing a stopper or positioning ring by welding and then shrinking an insertion portion, and in particular, precisely obtain the armature lift dispersion by controlling the number of weldings with a variable laser output.

According to the present disclosure, a method for controlling an armature lift feedback setting of an injector for a vehicle includes steps of: fixing a stopper to a needle bar and assembling an armature to the needle bar; performing a primary welding for a positioning ring by inserting the positioning ring into the needle bar, generating a primary deformation of the positioning ring, and forming a primary lift with respect to a target lift of a lower armature lift; and performing a secondary welding for the positioning ring by setting a number of weldings within a tolerance range of the primary lift with respect to the target lift and generating a secondary deformation of the positioning ring by the set number of weldings, thereby reaching the target lift.

Also, the primary deformation of the positioning ring may be achieved through a primary laser welding in a circumferential direction for the positioning ring. Further, the secondary deformation of the positioning ring may be achieved through a secondary laser welding in the circumferential direction for the positioning ring.

According to another aspect of the present disclosure, there is provided a method for an armature lift feedback setting of an injector, including fixing a stopper to a needle bar and assembling an armature to the needle bar, performing a primary welding for a positioning ring by inserting the positioning ring into the needle bar, generating a primary deformation of the positioning ring through a primary laser welding in a circumferential direction for the positioning ring, and forming a primary lift with respect to a target lift of a lower armature lift, and performing a secondary welding for the positioning ring by setting the number of weldings within a tolerance range of the primary lift with respect to the target lift and generating a secondary deformation of the positioning ring through a secondary laser welding in the circumferential direction for the positioning ring by the set number of weldings, thereby reaching the target lift.

An output of the primary laser welding is greater than that of the secondary laser welding so that the primary deformation of the positioning ring is greater than the secondary deformation.

When the tolerance range is 20%, the secondary laser welding aligned with the target lift sequentially reduces the amount of lift shrinkage with at least three welding outputs to reach the target lift, when the tolerance range is 15%, the secondary laser welding aligned with the target lift sequentially reduces the amount of lift shrinkage with at least two welding outputs to reach the target lift, and when the tolerance range is 10%, the secondary laser welding aligned with the target lift sequentially reduces the amount of lift shrinkage with one welding outputs to reach the target lift.

The primary laser welding uses a lower end portion of the ring body as a primary welding portion of the positioning ring, and the secondary laser welding uses a middle portion of the ring body as a secondary welding portion of the positioning ring, thereby moving upward toward the armature.

The positioning ring has a rigid body formed on a lower portion of a ring body portion through which a shaft hole having an inner diameter corresponding to a needle bar passes, the rigid body portion has a larger outer diameter than the ring body, the primary laser welding uses a lower end portion of the ring body as a primary welding portion of the positioning ring, the secondary laser welding uses a middle portion of the rigid body portion or a support portion as a secondary welding portion of the positioning ring to move upward toward the armature, and an output of the secondary laser welding is equal to or smaller than that of the primary laser welding.

According to the present disclosure, a method for controlling an armature lift feedback setting of an injector for a vehicle includes steps of: fixing a stopper to a needle bar and assembling an armature to the needle bar; performing a primary welding for a stopper by inserting the stopper into the needle bar, generating a primary deformation of the stopper, and forming a primary lift with respect to a target lift of an upper armature lift; and performing a secondary welding for the stopper by setting a number of weldings within a tolerance range of the primary lift with respect to the target lift and generating a secondary deformation of the stopper by the set number of weldings, thereby reaching the target lift.

Also, the primary deformation of the stopper may be achieved through a primary laser welding in a circumferential direction for the stopper. Further, the secondary deformation of the stopper may be achieved through a secondary laser welding in the circumferential direction for the stopper.

According to a further aspect of the present disclosure, there is provided a method for an armature lift feedback setting of an injector, including fixing a stopper to a needle bar and assembling an armature to the needle bar, performing a primary welding for a stopper by inserting the stopper into the needle bar, generating a primary deformation of the stopper through a primary laser welding in a circumferential direction for the stopper, and forming a primary lift with respect to a target lift of an upper armature lift, and performing a secondary welding for the stopper by setting the number of weldings within a tolerance range of the primary lift with respect to the target lift and generating a secondary deformation of the stopper through a secondary laser welding in the circumferential direction for the stopper by the set number of weldings, thereby reaching the target lift.

An output of the primary laser welding is greater than that of the secondary laser welding so that the primary deformation of the positioning ring is greater than the secondary deformation.

When the tolerance range is 20%, the secondary laser welding aligned with the target lift sequentially reduces the amount of lift shrinkage with at least three welding outputs to reach the target lift, when the tolerance range is 15%, the secondary laser welding aligned with the target lift sequentially reduces the amount of lift shrinkage with at least two welding outputs to reach the target lift, and when the tolerance range is 10%, the secondary laser welding aligned with the target lift sequentially reduces the amount of lift shrinkage with one welding outputs to reach the target lift.

The stopper forms a stopper body between a stopper upper flange forming an upper portion and a stopper lower flange forming a lower portion, the stopper body forms a gap with the needle bar through an expansion hole having a larger inner diameter larger than a shaft hole having an inner diameter corresponding to the needle bar, thereby performing the secondary laser welding, the primary laser welding applies the stopper upper flange to a primary welding portion of the stopper, and the secondary laser welding uses the stopper body as a secondary welding portion of the stopper to move downward toward the armature.

### BRIEF DESCRIPTION OF THE DRAWINGS

FIG. 1 illustrates an example of an injector to which an armature lift feedback setting according to the present disclosure is applied.

FIGS. 2A, 2B, and 2C illustrate an example of a method for an armature lift feedback setting of an injector, which forms a lower armature lift (i.e., a positioning ring side) of an injector according to the present disclosure.

FIG. 3 illustrates an example of a rigid deformation structure of a positioning ring.

FIG. 4 illustrates an example of a rigid deformation structure of a positioning ring according to the present disclosure.

FIGS. 5A, 5B, and 5C illustrate an example of a method for an armature lift feedback setting of an injector, which forms an upper armature lift (i.e., a stopper side) of an injector according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings, and these embodiments are examples and can be implemented in various different forms by those skilled in the art to which the present disclosure pertains, and thus are not limited to embodiments disclosed herein.

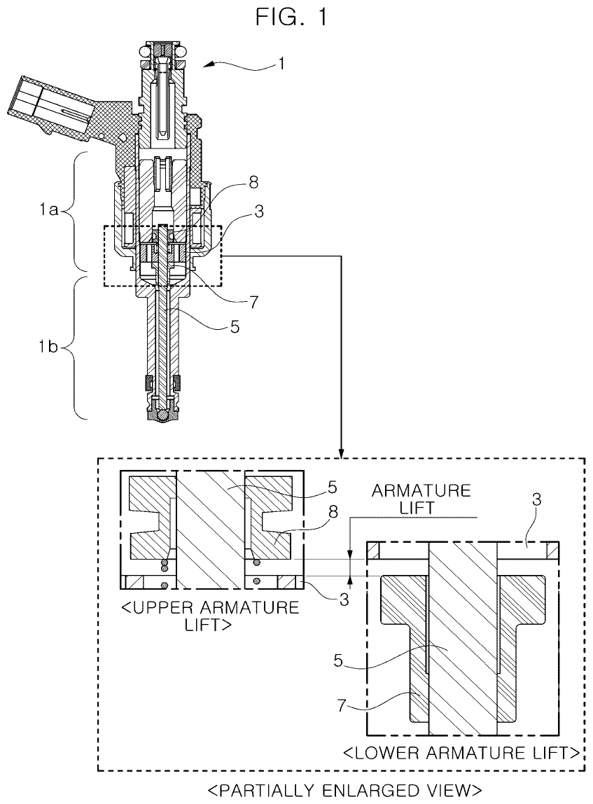

Referring to FIG. 1, an injector 1 includes a magnetic circuit unit 1a and an injector actuation unit 1b, and the magnetic circuit unit 1a includes an armature 3 together with a magnetic core/coil. The injector actuation unit 1b includes a stopper 8 together with a needle bar 5 and a positioning ring 7 and is connected to a ball/valve seat that is opened and closed by the needle bar 5.

Accordingly, the injector 1 is an injector operated by a solenoid, and together with the lifting of the armature 3, a needle (i.e., the needle bar 5) is lifted by a “magnetic force+armature impact force,” and the needle and the armature simultaneously move downward at a closing time point when a current signal is stopped so that the needle and the armature sequentially restore.

To this end, the armature 3 is moved upward by a magnetic force generated by the magnetic core/coil, receives an impact force generated when the armature 3 moves upward together with the magnetic force, and transmits the magnetic force to the stopper 8 that opens an injector valve. The needle bar 5 opens the injector valve through the ball of the valve seat when the armature 3 moves upward. The positioning ring 7 forms an armature-positioning ring impact surface at a closing time point of the injector valve, thereby controlling the behavior of the armature 3.

An armature lift of the injector 1 is formed as a lift set by a gap (or a distance) from a bottom surface of the stopper 8 to a top surface of the armature 3, which is referred to as an upper lift. In addition, a lift set by a gap (or a distance) from a top surface of the positioning ring 7 to a bottom surface of the armature 3 is referred to as a lower lift.

That is, the armature lift of the armature becomes the upper lift when the stopper is first fixed and then the lift is set according to the welding of the positioning ring, and becomes the lower lift when the positioning ring is first fixed and then the lift is set according to the welding of the stopper.

First, a process of forming the upper lift will be described.

The armature lift is determined by a position of the positioning ring 7 after the needle bar 5, the stopper 8, and the armature 3 are assembled, and the positioning ring 7 is fixed to the needle bar 5 by welding.

During cooling after welding, the positioning ring 7 shrinks, changing the lift between the positioning ring 7 and the bottom surface of the armature 3, and when a heat input increases due to an increase in welding output, deformation dispersion increases, resulting in an increase in lift dispersion.

Accordingly, in the present disclosure, the welding is not completed by a single first welding with a large heat input, and instead, the total heat input and the number of weldings are divided.

That is, a primary welding is performed with a primary heat input, a secondary welding is performed with a secondary heat input, and ultimately, to reduce the heat input and dispersion, the primary welding is performed, and then secondary and tertiary weldings are performed as needed, and the welding is performed from the bottom surface toward the top surface of the positioning ring 7, that is, toward the bottom surface of the armature, thereby reducing lift dispersion and achieving a target lift.

To this end, during an N^{th} welding, a primary laser welding, applying a large heat input in a circumferential direction through the needle bar 5, is performed to form a primary lift with large deformation dispersion.

A secondary laser welding is subsequently performed as a two-step laser welding process, in which a laser output determined based on setting data of the primary lift is applied in the circumferential direction without passing through the needle bar 5, thereby achieving the target lift.

Accordingly, an increase in the lift during the secondary laser welding is reduced compared to the primary laser welding, and the output of the secondary welding is equal to or smaller than that of the primary welding.

The heat input without passing through the needle bar 5 means that, unlike the laser output used for direct welding in the first step, from the second step onward, the laser is emitted from the outside, and thus welding heat is transferred through the positioning ring 7 but is prevented from affecting a welding surface through the needle bar 5.

Accordingly, among the primary and secondary weldings, the primary welding refers to the welding in which the output of the primary laser fixes the positioning ring 7 or the stopper 8 to the needle bar 5, while the secondary welding refers to the process in which the output of the secondary laser does not fix the positioning ring 7 or the stopper 8 to the needle bar 5, but partially melts the positioning ring 7 or the stopper 8 and then occurs only shrinkage due to cooling.

As defined above for the secondary welding, it should be understood that, hereinafter, “secondary welding” or “secondary laser welding” refers to the shrinkage caused by partial melting and subsequent cooling of the positioning ring 7 or the stopper 8, rather than the fixation of the positioning ring 7 or the stopper 8 to the needle bar 5.

In particular, the secondary laser welding is performed using a feedback setting method that uses the laser output having different heat inputs for each welding, which is determined based on a difference between the primary lift and the target lift, thereby achieving the target lift, and thus lift dispersion can be minimized after the primary and secondary weldings are completed.

In addition, except for the primary welding among multiple weldings, welding positions from the secondary welding onward are the same or are moved toward the armature 3. In this case, the welding position movement is the same in the positioning ring 7 or the stopper 8.

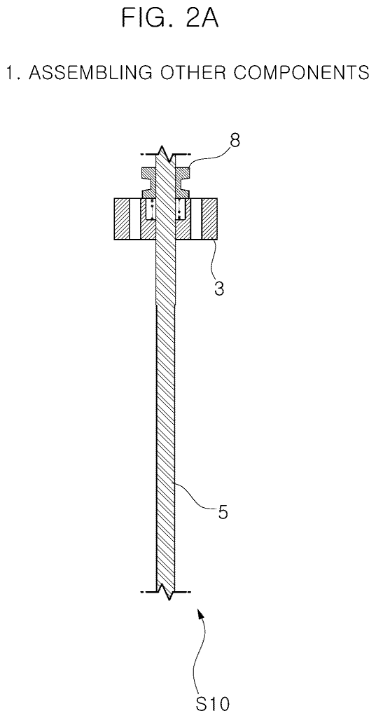

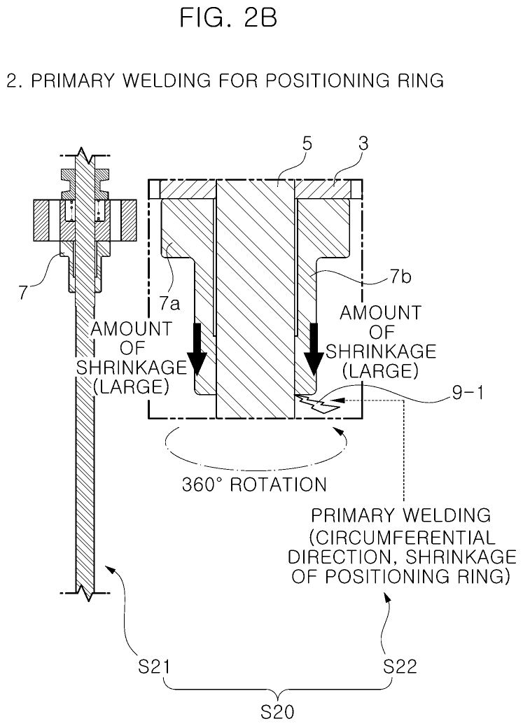

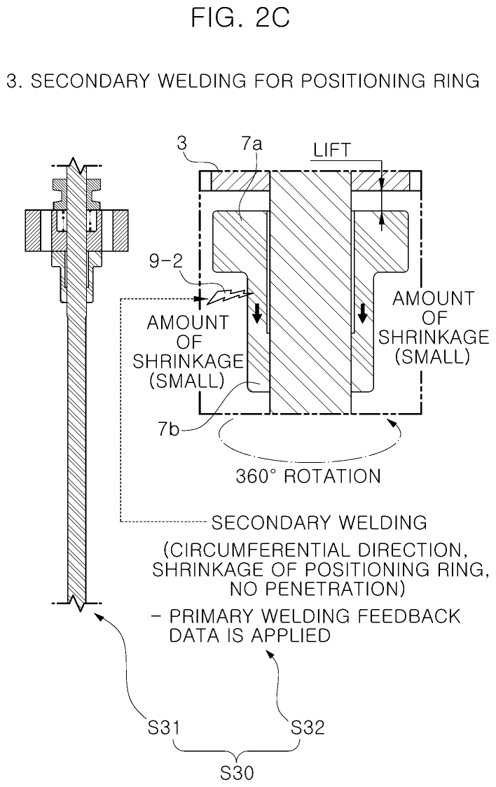

Referring to FIGS. 2A, 2B, and 2C, the method for an armature lift feedback setting of an injector 1 includes assembling other components (S10), performing a primary welding for a positioning ring (S20), and performing a secondary welding for the positioning ring (S30) and the lower armature lift set by the gap (or distance) between the top surface of the positioning ring 7 and the bottom surface of the armature 3 is applied to the injector 1.

As illustrated in FIG. 2A, the assembling of other components (S10) includes fixing the stopper 8 to the needle bar 5, assembling the armature 3 to the needle bar 5, inserting the positioning ring 7 into the needle bar 5, and assembling the stopper 8 above the armature 3 coupled to the needle bar 5.

Subsequently, as illustrated in FIG. 2B, the performing of the primary welding for the positioning ring (S20) includes assembling the positioning ring 7 to come into contact with the bottom surface of the armature 3 (S21), and applying primary laser welding to the positioning ring 7 so that the lower armature lift is formed roughly (S22).

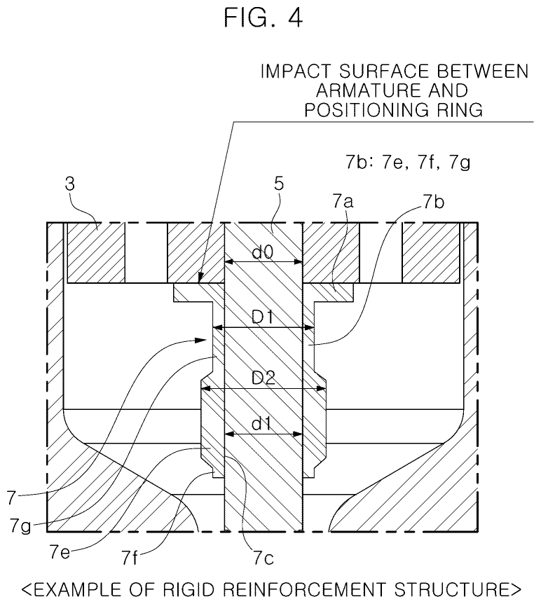

That is, by fixing the stopper and the armature to the needle bar using the above method and then performing the welding of the positioning ring in multiple stages, it is possible to set the lower lift to reach the target lift while reducing lift dispersion. Meanwhile, by first assembling the positioning ring and the armature and performing the welding of the stopper in multiple stages, it is also possible to set the upper lift to reach the target lift while reducing lift dispersion, which will be described again in FIG. 4.

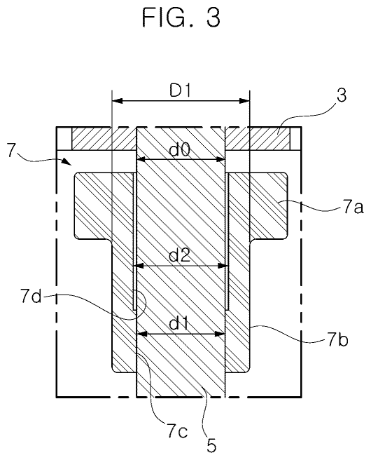

Referring to FIG. 3, the positioning ring 7 includes a ring body 7b that has a smaller diameter than a ring flange 7a forming an impact surface with the armature 3 and is fixed to the needle bar 5, and a hole to which the needle bar 5 is coupled is divided into an axial hole 7c and an expansion hole 7d formed to have a cross-sectional structure of different diameters.

For example, the assembly of the needle bar 5 and the positioning ring 7 is achieved by interfitting a needle bar outer diameter d0 into a first positioning ring inner diameter d1 of the shaft hole 7c, with their diameters being the same. On the other hand, since a secondary positioning ring inner diameter d2 in the expansion hole 7d is formed to have a gap with the needle bar outer diameter d0, the second positioning ring inner diameter d2 in the expansion hole 7d is larger than the first positioning ring inner diameter d1 in the shaft hole 7c, and thus the hole is formed with a stepped cross-sectional structure having different diameters.

Accordingly, the position of the primary laser welding for the positioning ring 7 is unconditionally determined to be below the ring body 7b of the positioning ring 7, and an upper portion of the ring body 7b forming the expansion hole 7d becomes the position of the secondary laser welding, and thus the position of the secondary laser welding is moved upward from the positioning ring 7 toward the armature 3 compared to the primary position, as illustrated in FIG. 2C.

In addition, the output of the secondary laser welding is equal to or smaller than that of the primary laser welding.

Referring to FIG. 4, the positioning ring 7 may have a rigid reinforcement structure, the rigid reinforcement structure is composed of the ring body 7b having a structure of the ring flange 7a, a rigid body portion 7e, a fixed end portion 7f, and a support portion 7g, and a shaft hole 7c having the same size as the outer diameter d0 of the needle bar 5, and an outer diameter D2 of the rigid body portion 7e has a larger diameter than outer diameters D1 of the fixed end portion 7f and the support portion 7g, thereby forming the ring body 7b in a protruding structure.

That is, the outer diameter D2 of the rigid body portion 7e is thicker than a difference in diameters (D1-d1) between the outer diameter D1 of the support portion 7g and the first positioning ring inner diameter d1 in the shaft hole 7c due to a difference in diameters (D2-d1) between the outer diameter D1 of the support portion 7g and the first positioning ring inner diameter d1 in the shaft hole 7c. This increased thickness prevents excessive product deformation even when the secondary laser welding of the precision setting (i.e., the target lift) for the positioning ring 7 passes through the rigid body portion 7e when the support portion 7g is thin.

Accordingly, when the positioning ring 7 of a rigid reinforcement structure type is applied, the primary laser welding (S22) is applied to the fixed end portion 7f, but the secondary laser welding (S32) is applied to the rigid body portion 7e.

In this way, the position of the primary laser welding for the positioning ring 7 is unconditionally determined to be the fixed end portion 7f, and the rigid body portion 7e or the support portion 7g becomes the position of the secondary laser welding, and thus the position of the secondary laser welding move upward from the positioning ring 7 toward the armature 3 compared to the position of the primary laser welding.

In addition, the output of the secondary laser welding may be equal to or smaller than that of the primary laser welding without any increase due to the rigid body portion 7e.

Furthermore, when a radius of the positioning ring 7 becomes larger due to the presence of the rigid body portion 7e, the position of the secondary laser welding may adjust the amount of shrinkage in the following order: “primary lift (amount of shrinkage)>secondary lift (amount of shrinkage)>tertiary lift (amount of shrinkage)” through laser output and position selection.

Accordingly, when the target lift is not reached, the welding position of the rigid body portion 7e may be used as it is, a tertiary welding may be performed by moving upward from the section of the rigid body portion 7e or moving to an elastic deformation portion, which is the support portion 7g connected to the rigid body portion 7e.

Referring back to FIG. 2B, in the assembling of the positioning ring (S21), the ring flange 7a, which is inserted into the expansion hole 7d of the positioning ring 7 from the bottom of the needle bar 5, is positioned on the bottom surface of the armature 3. In this case, the positioning ring 7 may be coupled to the needle bar 5 by the shaft hole 7c having the first positioning ring inner diameter d1 corresponding to the needle bar outer diameter d0, and in particular, may be fixedly press-fitted due to the difference in diameters.

In addition, the primary laser welding (S22) for the positioning ring is performed in the circumferential direction with an end portion of the ring body 7b of the positioning ring 7 as a primary welding portion 9-1, and the primary laser welding uses a laser output with a large heat input, which passes through the needle bar 5. In this case, the primary laser welding is applied to only one portion of the positioning ring 7 to allow a 360° rotation, and particularly, a large amount of deformation is formed in the lower portion of the positioning ring 7 to which the primary laser welding was applied.

Subsequently, after the primary laser welding is completed, the positioning ring 7 measures a primary lift of the lower armature lift formed due to deformation, and the primary lift is defined as follows.

For example, when the target lift is set to 100±5 μm (95 to 105), the primary welding is performed by setting the primary lift to 80 to 100 μm, and thus a maximum tolerance range of 20 μm is applied.

Accordingly, the primary lift is set to a tolerance range of about 20% of the target lift as setting data, and the setting data allows the secondary laser welding, which uses different laser outputs according to the number of weldings, to reach the target lift using a feedback setting method.

Subsequently, the performing of the secondary welding (S30) for the positioning ring, as illustrated in FIG. 2C, includes checking the primary lift for the positioning ring (S31), and applying the secondary laser welding to the positioning ring 7 so that the primary lift reaches the target lift (S32).

For example, the checking of the primary lift for the positioning ring (S31) may be omitted when the secondary laser welding is performed immediately using data measured after the primary laser welding is completed, but when a product stored in inventory after the primary laser welding is taken out and used, the tolerance range of the primary lift is remeasured to obtain setting data that determines different laser outputs according to the number of weldings of the secondary laser welding.

In addition, the secondary laser welding (S32) for the positioning ring is performed in the circumferential direction with a middle portion of the ring body 7b of the positioning ring 7 as a secondary welding portion 9-2 at a side opposite to the primary laser welding application portion, and the secondary laser welding uses laser output with a heat input that does not pass through the needle bar 5. In this case, the positioning ring 7 is subjected to the secondary laser welding only on one side to allow a 360° rotation, and particularly, since the secondary laser welding has a lower heat input than the primary laser welding, the deformation of the middle portion to which the secondary laser welding was applied is smaller than that of the primary laser welding.

For example, the number of weldings and laser output of the secondary laser welding are classified into about 20%, 15%, or 10% tolerance ranges based on the primary setting result of the primary lift with respect to the target lift. The number of weldings is set to three when the primary setting result falls within the 20% tolerance range, set to two when the primary setting result falls within the 15% tolerance range, and set to one when the primary setting result falls within the 10% tolerance range, and as the number of weldings increases, the secondary laser output is set to be smaller.

For example, an example of the secondary welding output according to the primary lift data is as follows.

Based on the target lift (100±5 μm (95 to 105)) for the positioning ring 7 of the lower armature lift, the primary setting (=primary welding output setting-welding position is a lower end portion of the positioning ring 7) is set to a target of 80 to 100 μm, and the welding of the positioning ring 7 (tolerance range of 20 μm) is performed upward toward the armature, and then when a difference from the primary lift according to the primary setting is large, the secondary setting (the welding output is reduced, the welding position is moved upward, or both are simultaneously performed) is used to shrink the primary lift by the amount of the secondary lift and compare it with the target lift.

When the secondary lift is insufficient, the laser output is reduced at the same position, or when the laser output is the same, the position is further moved upward so that the sum of the shrinkage up to the tertiary lift is the same as the target lift.

For example, the primary lift (amount of shrinkage) may be a case in which the first setting result is 90 μm, the secondary lift (amount of shrinkage) may be a case in which the primary setting result is 85 μm, and the tertiary lift (amount of shrinkage) may be a case in which the primary setting result is 80 μm.

However, the number of laser weldings for the positioning ring 7 is merely an example, and the goal is to reach the target lift by adding the amounts of shrinkage in each stage, such as “primary lift (amount of shrinkage)>secondary lift (amount of shrinkage)>tertiary lift (amount of shrinkage).”

In addition, the position of the secondary laser welding has been described using the structure of the positioning ring 7, but this means that, except for the position of the primary laser welding, the position of the secondary laser welding is the same as that of the primary welding or is moved further toward the armature.

Accordingly, the secondary laser welding (S32) enables precise setting for the target lift of the positioning ring 7 by multiple laser weldings using a small laser output suitable for reducing lift dispersion with a variable laser output compared to the existing fixed output.

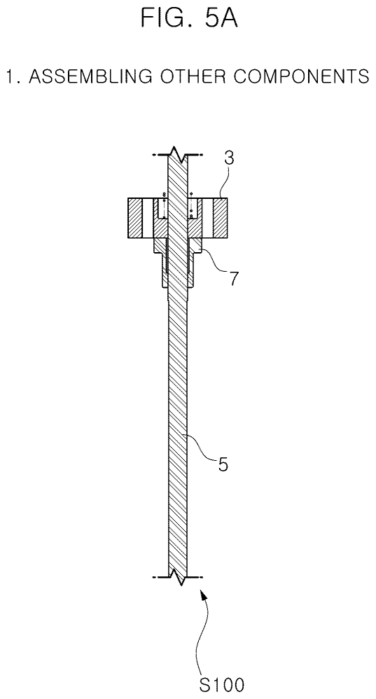

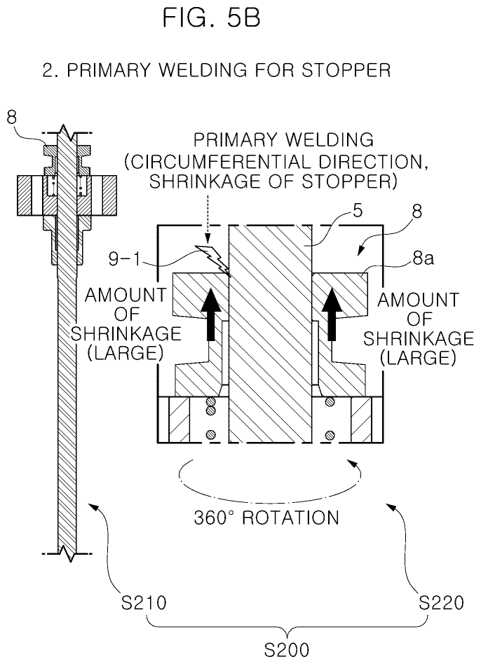

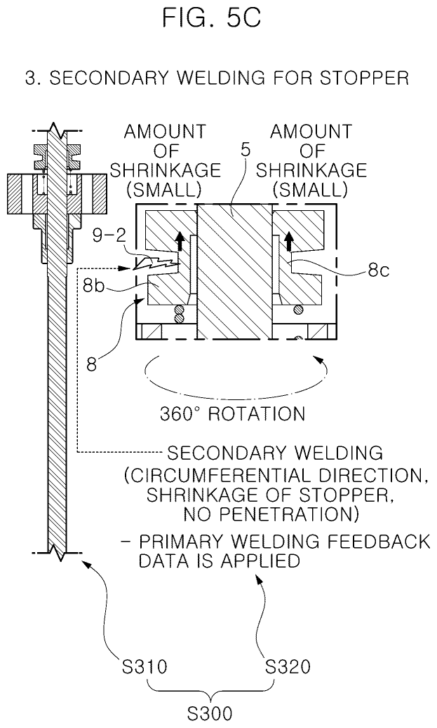

Referring to FIGS. 5A, 5B, and 5C, the method for an armature lift feedback setting of the injector 1 includes assembling other components (S100), performing a primary welding for a stopper (S200), and performing a secondary welding for the stopper (S300), and the upper armature lift set by the gap (or distance) between a bottom surface of a stopper 8 and a top surface of the armature 3 is applied to the injector 1.

To this end, the stopper 8 includes a stopper body 8c, a stopper upper flange 8a forming an upper portion of the stopper body 8c with a larger diameter than the body, and a stopper lower flange 8b forming a lower portion of the stopper body 8c with a larger diameter than the body. In this case, a shaft hole and an expansion hole, which have the same structure and perform the same function as those of the shaft hole 7c and expansion hole 7d of the positioning ring 7 of FIG. 3, are formed.

As illustrated in FIG. 5A, the assembling of other components (S100) includes fixing the positioning ring 7 to the needle bar 5, assembling the armature 3 to the needle bar 5, and assembling the positioning ring 7 below the armature 3 coupled to the needle bar 5.

As illustrated in FIG. 5B, the performing of the primary welding for the stopper (S200) includes assembling the stopper 8 to come into contact with the top surface of the armature 3 (S210), and applying primary laser welding to the stopper 8 so that the upper armature lift is formed roughly (S220).

For example, the assembling of the stopper (S210) is performed such that a stopper lower flange 8b, which is inserted into an expansion hole of the stopper 8 from above the needle bar 5, is positioned on the top surface of the armature 3. In this case, the stopper 8 may be coupled to the needle bar 5 through the shaft hole and may be particularly fixedly press-fitted due to a difference in diameters.

In addition, the primary laser welding (S220) for the stopper is performed in the circumferential direction with an end portion of the stopper upper flange 8a of the stopper 8 as the primary welding portion 9-1, and the primary laser welding uses a laser output with a large heat input, which passes through the needle bar 5. In this case, the primary laser welding is applied to only one portion of the stopper 8 to allow a 360° rotation, and particularly, a large amount of deformation is formed in the lower portion of the stopper 8 to which the primary laser welding was applied.

Subsequently, once the primary laser welding is completed, the primary lift of the upper armature lift formed due to the deformation of the stopper 8 is measured, and the primary lift applies the same tolerance range of about 20% as that for the primary lift described in FIGS. 2A, 2B, and 2C.

The performing of the secondary welding (S300) for the stopper, as illustrated in FIG. 5C, includes checking the primary lift for the stopper (S310), and applying the secondary laser welding to the stopper 8 so that the primary lift reaches the target lift (S320).

For example, the checking of the primary lift for the stopper (S310) may be omitted, as in the positioning ring 7, or may be remeasured when a product stored in stock is taken out and used.

In addition, the secondary laser welding (S320) for the stopper is performed in the circumferential direction with a middle portion of the stopper body 8c as the secondary welding portion 9-2 at the same side as the primary laser welding application portion of the stopper body 8c of the stopper 8, and the secondary laser welding uses laser output with a heat input that does not pass through the needle bar 5. In this case, the stopper 8 is subjected to the secondary laser welding only on one side to allow a 360° rotation, and particularly, since the secondary laser welding has a lower heat input than the primary laser welding, the deformation of the middle portion to which the secondary laser welding was applied is smaller than that of the primary laser welding.

Accordingly, in the case of the stopper, as in the positioning ring, an example of the secondary welding output based on the primary lift data is as follows.

Based on the target lift (100±5 μm (95 to 105)) of the upper armature lift, the primary setting (=primary welding output setting-welding position is an upper end portion of the stopper 8) is set to a target of 80 to 100 μm, and the welding of the stopper 8 (tolerance range of 20 μm) is performed downward from the armature, and then when a difference from the primary lift according to the primary setting is large, the secondary setting (the welding output is reduced, the welding position is moved downward, or both are simultaneously performed) is used to shrink the primary lift by the amount of the secondary lift and compare it with the target lift.

When the secondary lift is insufficient, the laser output is reduced at the same position, or when the laser output is the same, the position is further moved downward so that the sum of the shrinkage up to the tertiary lift is the same as the target lift.

For example, the primary lift (amount of shrinkage) may be a case in which the first setting result is 90 μm, the secondary lift (amount of shrinkage) may be a case in which the primary setting result is 85 μm, and the tertiary lift (amount of shrinkage) may be a case in which the primary setting result is 80 μm.

However, the number of laser weldings for the stopper 8 is merely an example, and the goal is to reach the target lift by adding the amounts of shrinkage in each stage, such as “primary lift (amount of shrinkage)>secondary lift (amount of shrinkage)>tertiary lift (amount of shrinkage).”

In addition, the position of the secondary laser welding has been described using the structure of the stopper 8, but this means that, except for the position of the primary laser welding, the position of the secondary laser welding is the same as that of the primary welding or is moved further toward the armature.

Accordingly, the secondary laser welding (S320) enables precise setting for the target lift of the stopper 8 by multiple laser weldings using a small laser output suitable for reducing lift dispersion with a variable laser output compared to the existing fixed output.

As described above, in the method for an armature lift feedback setting of an injector according to the present embodiment, the primary lift may be formed by deforming the positioning ring 7 or the stopper 8 through the primary laser welding in the circumferential direction with the lower end portion of the positioning ring 7 or the upper end portion of the stopper 8 as the first welding portion 9-1, and the target lift may be reached through the secondary laser welding in the circumferential direction performed by the number of weldings set according to the tolerance range of the primary lift with respect to the target lift with the middle portion of the positioning ring 7 or the stopper 8 as the secondary welding portion 9-2, adjusting the number of secondary laser weldings and the number of weldings according to the variable laser output, thereby precisely obtaining the armature lift dispersion with respect to the positioning ring 7 or the stopper 8.

According to the method for an armature lift feedback setting of an injector of the present disclosure, by reducing armature lift dispersion, it is possible to improve flow rate distribution and behavior and improve ease of management.

In particular, in response to the diversification of lift specifications, variable laser output can be controlled such that a higher output is applied to a larger lift and a lower output is applied to a smaller lift, when a larger lift is required, the number of weldings can be increased by performing multiple weldings more than once, and by securing a state in which conventional processes are applied as stock and setting the required lift through the application of a new process, inventory management of the injector component can be facilitated.

What is claimed is:

1. A method for controlling an armature lift feedback setting of an injector for a vehicle, the method comprising:
fixing a stopper to a needle bar and assembling an armature to the needle bar;
performing a primary welding for a positioning ring by inserting the positioning ring into the needle bar, generating a primary deformation of the positioning ring, and forming a primary lift with respect to a target lift of a lower armature lift; and
performing a secondary welding for the positioning ring by setting a number of weldings within a tolerance range of the primary lift with respect to the target lift and generating a secondary deformation of the positioning ring by the set number of weldings, thereby reaching the target lift.

2. The method of claim 1, wherein the primary deformation of the positioning ring is achieved through a primary laser welding in a circumferential direction for the positioning ring.

3. The method of claim 2, wherein the secondary deformation of the positioning ring is achieved through a secondary laser welding in the circumferential direction for the positioning ring.

4. The method of claim 3, wherein an output of the primary laser welding is greater than that of the secondary laser welding so that the primary deformation of the positioning ring is greater than the secondary deformation.

5. The method of claim 1, wherein the primary lift generated by the primary welding sets a tolerance range to one of 20%, 15%, or 10% of the target lift.

6. The method of claim 5, wherein, when the tolerance range is 20%, the secondary welding aligned with the target lift sequentially reduces the amount of lift shrinkage with at least three welding outputs to reach the target lift.

7. The method of claim 5, wherein, when the tolerance range is 15%, the secondary welding aligned with the target lift sequentially reduces the amount of lift shrinkage with at least two welding outputs to reach the target lift.

8. The method of claim 5, wherein, when the tolerance range is 10%, the secondary welding aligned with the target lift sequentially reduces the amount of lift shrinkage with one welding outputs to reach the target lift.

9. The method of claim 1, wherein the positioning ring includes a ring body passing through an expansion hole having a larger inner diameter than a shaft hole having an inner diameter corresponding to the needle bar, and
the inner diameter of the expansion hole forms a gap with the needle bar, thereby performing the secondary welding.

10. The method of claim 9, wherein positions of the primary welding and the secondary welding are moved to a position toward the armature from the position of the secondary welding, excluding the position of the primary welding.

11. The method of claim 1, wherein the positioning ring has a rigid body formed on a lower portion of a ring body portion through which a shaft hole having an inner diameter corresponding to a needle bar passes, and
the rigid body portion has a larger outer diameter than the ring body.

12. The method of claim 11, wherein the positions of the primary welding and the secondary welding are moved toward the armature from the position of the secondary welding, excluding the position of the primary welding, and
an output of the secondary welding is equal to or smaller than that of the primary welding.

13. A method for controlling an armature lift feedback setting of an injector for a vehicle, the method comprising:
fixing a stopper to a needle bar and assembling an armature to the needle bar;
performing a primary welding for a stopper by inserting the stopper into the needle bar, generating a primary deformation of the stopper, and forming a primary lift with respect to a target lift of an upper armature lift; and
performing a secondary welding for the stopper by setting a number of weldings within a tolerance range of the primary lift with respect to the target lift and generating a secondary deformation of the stopper by the set number of weldings, thereby reaching the target lift.

14. The method of claim 13, wherein the primary deformation of the stopper is achieved through a primary laser welding in a circumferential direction for the stopper.

15. The method of claim 14, wherein the secondary deformation of the stopper is achieved through a secondary laser welding in the circumferential direction for the stopper.

16. The method of claim 15, wherein an output of the primary laser welding is greater than that of the secondary laser welding so that the primary deformation of the stopper is greater than the secondary deformation.

17. The method of claim 13, wherein the primary lift generated by the primary welding sets a tolerance range to one of 20%, 15%, or 10% of the target lift.

18. The method of claim 13, wherein:
when the tolerance range is 20%, the secondary welding aligned with the target lift sequentially reduces the amount of lift shrinkage with at least three welding outputs to reach the target lift;
when the tolerance range is 15%, the secondary welding aligned with the target lift sequentially reduces the amount of lift shrinkage with at least two welding outputs to reach the target lift; and
when the tolerance range is 10%, the secondary welding aligned with the target lift sequentially reduces the amount of lift shrinkage with one welding outputs to reach the target lift.

19. The method of claim 11, wherein the stopper forms a stopper body between a stopper upper flange forming an upper portion and a stopper lower flange forming a lower portion, and
the stopper body forms a gap with the needle bar through an expansion hole having a larger inner diameter larger than a shaft hole having an inner diameter corresponding to the needle bar, thereby performing the secondary laser welding.

20. The method of claim 19, wherein positions of the primary laser welding and the secondary laser welding are moved to a position toward the armature from the position of the secondary laser welding, excluding the position of the primary laser welding.
